(19) United States
(12) Patent Application Publication
(10) Pub. No.: US 2026/0184432 A1
(43) Pub. Date: Jul. 2, 2026

(54) AIR INLET INTENDED TO BE CONNECTED TO A FAN CASING OF A TURBINE ENGINE BY A FLANGE-TYPE ASSEMBLY AND PROPULSION ASSEMBLY COMPRISING A TURBINE ENGINE EQUIPPED WITH SUCH AN AIR INLET

(71) Applicant: SAFRAN NACELLES, Gonfreville-L'Orcher (FR)

(72) Inventors: Alexis Yves-Marie LONCLE, Moissy-Cramayel (FR); Jeremie RABINEAU, Moissy-Cramayel (FR)

(73) Assignee: SAFRAN NACELLES, Gonfreville-L'Orcher (FR)

(21) Appl. No.: 19/130,235

(22) PCT Filed: Nov. 20, 2023
(86) PCT No.: PCT/FR2023/051827

§ 371 Date: May 15, 2025

(30) Foreign Application Priority Data
Nov. 28, 2022 (FR) FR2212385

(51) Int. Cl. B64D 33/02; F01D 25/24; F02C 7/045

(52) U.S. Cl. CPC B64D 33/02; F01D 25/243; F02C 7/045; B64D 2033/0206; F05D 2250/191

(57) ABSTRACT

An air inlet to be connected to a fan casing of a turbine engine by a flange-type assembly. The air inlet includes an annular structure of longitudinal axis including an inner shroud and an outer shroud, the inner shroud at least partially delimiting a radially outer wall of a flow path for an airflow in the turbine engine in a substantially longitudinal direction. The air inlet includes a flange having a bearing face of a clamping member. The air inlet is arranged such that the bearing face is accessible from the flow path via an access port. A propulsion assembly includes such an air inlet.

### TECHNICAL FIELD OF THE INVENTION

The present invention relates to the field of aircraft turbine engine nacelles, and more specifically to the air inlets equipping such nacelles.

It relates more specifically to the junction of an air inlet on the nacelle casing, also referred to as fan casing in the case of a twin-flow turbine engine. The invention applies to all turbine engine designs, for example, turbofans driven directly by a low-pressure spool, driven indirectly by a reduction gear, single-spool, twin-spool, single-flow and twin-flow turbojets.

### PRIOR ART

In a turbine engine, here a turbojet of central axis AX, air is admitted, in a longitudinal direction parallel to the axis AX, into an inlet duct to pass through a fan comprising a series of rotary blades before splitting into a central primary flow which flows in a so-called flow path of a primary airflow and a secondary flow surrounding the primary flow.

The primary flow is compressed by compressor stages before reaching a combustion chamber, after which it expands by passing through turbines, before being discharged by generating a thrust. The secondary flow is propelled directly by the fan to generate the main thrust.

The turbojet also comprises a nacelle which supports the turbojet elements and ensures the connection of the turbojet to the aircraft. The nacelle comprises a fan casing at the upstream end of which an air inlet-also referred to as air inlet lip—is mounted. The air inlet conventionally comprises an annular structure and a substantially transverse rear partition which connects a radially inner shroud and a radially outer shroud of the annular structure. From patent application FR3095416, an air inlet connected to the fan casing using flanges screwed onto each other is known. The air inlet comprises a first flange intended to be connected to a second flange of the fan casing using clamping bolts. The bearing surface of the first flange to allow the positioning and clamping of the bolt is conventionally accessed from a radially outer zone located downstream of the bearing surface. Conventionally, a panel of an outer shroud of the fan casing is removed to allow access to the bearing surface. There are “extended lip” type air inlets wherein the outer shroud extends upstream of the rear partition. This type of inlet makes it much more complex to access the bearing face from the fan casing and requires the use of expensive and constraining special tools. Finally, checking the conformity of the assembly is also more difficult. This results in an increased cost of assembly and inspection of such air inlets as well as a higher risk of non-conformity due to the complexity of the assembly and inspection operations.

### Disclosure of Invention

The aim of the present invention is that of reducing the costs of assembling an air inlet on a turbine engine, in particular by facilitating the assembly and disassembly operations of the air inlet lip.

For this purpose, an air inlet intended to be connected to a fan casing of a turbine engine by a flange-type assembly is provided. The air inlet comprises an annular structure of longitudinal axis comprising an inner shroud and an outer shroud, the inner shroud at least partially delimiting a radially outer wall of a flow path for an airflow in the turbine engine in a substantially longitudinal direction. The air inlet comprises a flange having a bearing face of a clamping member. According to the invention, the air inlet is arranged such that the bearing face is accessible from the flow path via an access port.

This results in an air inlet with easier assembly and inspection operations, thus reducing assembly costs while improving reliability. Indeed, the assembly and disassembly operations of the air inlet lip are possible despite access from the outside being impossible.

According to other particular, non-exclusive and optional embodiments of the invention:
the flange comprises a core extending substantially longitudinally and a first portion projecting substantially radially inward, the first portion bearing the bearing face;
the flange comprises an outer wing extending circumferentially about the longitudinal axis, and the outer wing comprises a first clamping connection surface with the inner shroud and/or the air inlet comprises a substantially transverse rear partition connecting the inner shroud and the outer shroud, and the flange comprises a second clamping connection surface with the rear partition;
the first clamping connection surface extends circumferentially about the longitudinal axis and/or the second clamping connection surface extends in a direction substantially orthogonal to the longitudinal axis;
the flange is in material continuity with the inner shroud;
the air inlet comprising a removable covering for sealing the access port;
means for attaching the removable covering comprise a first inner wing extending at least partially circumferentially about the longitudinal axis;
the first inner wing is connected to the flange by a support;
the first inner wing is in material continuity with the flange;
means for attaching the removable covering comprise a second inner wing extending at least partially circumferentially about the longitudinal axis and located downstream of the first inner wing;
the second inner wing is in material continuity with the flange;
the covering comprises a base for connecting with the flange, the base comprising a bore for receiving a screw for attaching the covering to the flange;
the covering is perforated.

Other features and advantages of the invention will appear upon reading the following description of particular non-limiting embodiments of the invention.

### BRIEF DESCRIPTION OF THE FIGURES

The invention will be better understood upon reading the following description, given as a non-limiting example, and made with reference to the figures which represent:

FIG. 1 is a schematic sectional representation of a turbojet equipped with the air inlet according to the invention;

FIG. 2 is a schematic partial detailed sectional representation of the air inlet according to a first embodiment of the invention;

FIG. 3 is a schematic partial detailed sectional representation of the air inlet according to a second embodiment of the invention;

FIG. 4 is a schematic partial detailed sectional representation of the air inlet of the embodiment of FIG. 2;

FIG. 5 is a schematic partial detailed sectional representation of the air inlet according to a third embodiment of the invention;

FIG. 6 is a schematic partial detailed sectional representation of the air inlet according to a fourth embodiment of the invention;

FIG. 7 is a schematic partial detailed sectional representation of the air inlet according to a fourth embodiment of the invention.

### DESCRIPTION OF THE EMBODIMENTS

With reference to FIG. 1, a propulsion assembly 1000 comprises a turbine engine, here a turbojet generally referenced 1, wherein an airflow 100 is admitted, in a longitudinal direction parallel with the axis AX of rotation of the turbine engine 1, into an inlet duct 2 to pass through a fan including a series of rotary blades 3.

Part of the airflow 100 is compressed by compressor stages 4 and 5 before reaching a combustion chamber 6, after which it expands by passing through turbines 7, before being discharged by generating a thrust. The remainder of the airflow 100 is in turn propelled directly by the fan to generate the main thrust.

Herein, the terms “internal” or “inner” and “external” or “outer” are used with reference to the position or orientation relative to the axis of rotation of the turbines 7.

Herein, the terms “upstream” and “downstream” are used with reference to the position or orientation of an element in the flow direction of the airflow 100 in the turbojet 1.

The turbojet 1 also comprises a nacelle 8 which supports the elements of the turbojet 1 and ensures its connection to an aircraft not shown. The nacelle 8 comprises a fan casing 9 wherein the upstream end particularly comprises an upstream casing flange 9.1 on which an air inlet 10 is mounted. The upstream flange 9.1 comprises a disk 9.2 which extends radially from the casing 9 outward.

The air inlet 10 comprises an annular structure 11 of longitudinal axis merged with the axis AX and comprises an inner shroud 12 and an outer shroud 13. The outer shroud 13 extends downstream of a substantially transverse rear partition 14 which connects the shroud 12 and the shroud 13 to define a so-called “extended lip” air inlet.

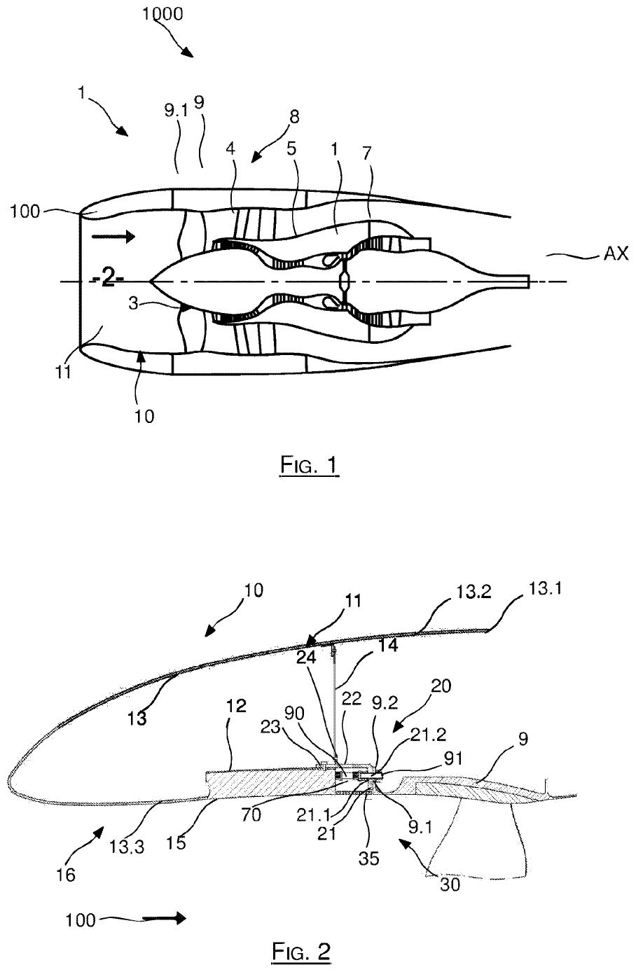

The annular structure 11 also comprises a substantially transverse rear partition 14 which connects the inner shroud 12 and the outer shroud 13. As seen in FIG. 2, the inner shroud 12 delimits a radially outer wall 15 of a flow path 16 of the airflow 100. The inner shroud 12 is, here, equipped with acoustic protection. The air inlet 10 also comprises a flange 20 intended to receive the casing flange 9.1 and which has a first portion 21 projecting radially inward and which defines the bearing face 21.1. The bearing face 21.1 is intended to receive a clamping force of a clamping member-here a plurality of screws 90 engaged in axial perforations 21.2 of the flange 20. The screws 90 work together with cage nuts 91 of the flange 9.1.

An air inlet 10 is referred to as “extended lip” when a downstream end 13.1 of an outer face 13.2 of the air inlet 10 is located downstream of the downstream end of the inner face 13.3 of the air inlet lip-here the flange 20.

Hereinafter in the description, the parts being revolving parts or sectors of such parts, only a cross-section will be described, it being understood that such a cross-section is conventionally repeated according to a rotation of longitudinal axis AX.

The flange 20 comprises a radially outer core 22 which extends circumferentially about the longitudinal axis AX and which comprises a first clamping connection surface 23 with the inner shroud 12 and a second clamping connection surface 24 with the rear partition 14. The first surface 23 extends, here, circumferentially about the longitudinal axis AX and the second surface 24 extends in a direction substantially orthogonal to the longitudinal axis AX. The flange 20 therefore comprises a core 22 extending substantially longitudinally. The first portion 21 extends projecting substantially radially inward from the core 22.

As seen in FIG. 2, the arrangement of the flange 20 and the inner shroud 12 defines an access port 30 which makes it possible to access the bearing face 21.1 and to position and/or clamp the screws 90 from the flow path 16. Thus, the air inlet 10 is arranged such that the bearing face 21.1 is accessible from the flow path 16 via the access port 30.

For the purposes of the present application, the bearing face 21.1 is referred to as accessible when it is possible to position the screw 90 or clamp it using a tool from the flow path 16 when the air inlet 10 is in the assembly position.

Elements that are identical or analogous to those described above have a reference numeral that is identical thereto in the following description of a second, third and fourth embodiment of the invention.

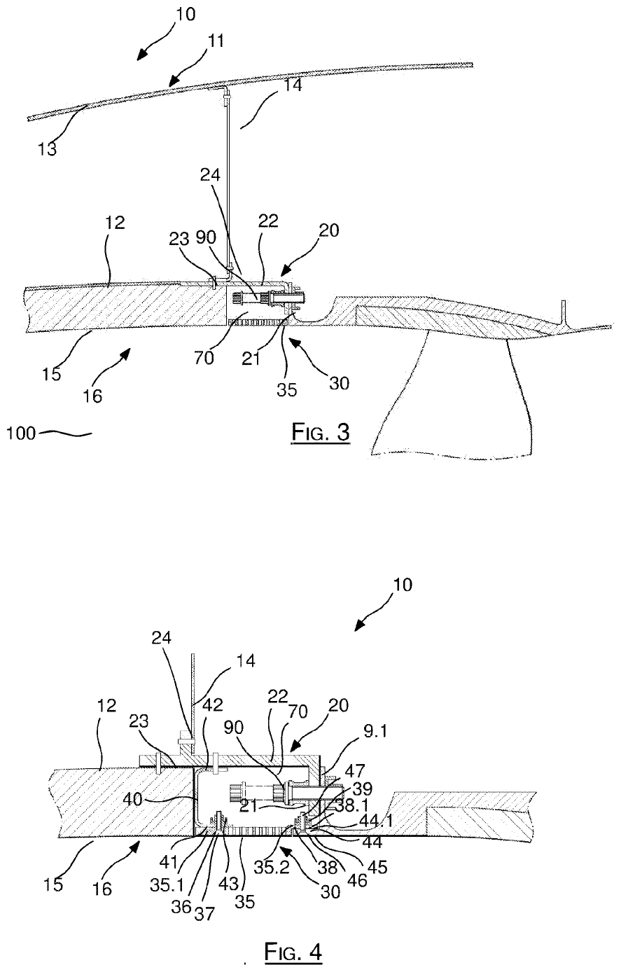

According to a second embodiment of the invention shown in FIG. 3, the flange 20 is in material continuity with the inner shroud 12 and comprises an angle-shaped profile 25 mounted by riveting to the core 22 of the flange 20 such that the upper wing 26 of the flange 20 is mounted by bolting. The upper wing 26 forms the second clamping connection surface 24 with the rear partition 14.

As seen in FIGS. 2 and 3, the air inlet 10 comprises a removable covering 35 for sealing the access port 30. The covering 35 defines, with the flange 20 and the shroud 12, a first cavity 70. The covering 35 is, here, perforated, i.e. it comprises a plurality of perforations which allow aeraulic communication between the cavity 70 and the flow path 16, which allows acoustic attenuation.

Advantageously, the cavity 70 can receive a honeycombed acoustic insert which improves the acoustic attenuation further.

As seen in FIG. 4, the flange 20 comprises a first U-shaped profile 40, the first inner wing 41 of which extends circumferentially about the longitudinal axis AX and the first outer wing 42 of which is screwed onto the core 22 of the flange 20. The first inner wing 41 is radially recessed from the wall 15 by a distance substantially equal to the thickness of the covering 35 and comprises a cage nut 43. The casing flange 9.1 has a second inner wing 44 which extends circumferentially about the longitudinal axis AX. The inner surface 45 of the wing 44 extends substantially at the same level as the wall 15 to define the flow path 16. The wing 44 comprises a downstream countersink 46 for accommodating a screw 47. The first inner wing 41 forms a first attachment point of the covering 35 on the flange 20. The second inner wing 44 forms a second attachment point of the covering 35 on the casing 9.

The covering 35 comprises, here, at its upstream end 35.1, an upstream countersink 36 for accommodating a screw 37. The downstream end 35.2 of the covering 35 comprises, for its part, a tab 38 which is radially recessed from the wall 15 by a distance substantially equal to the thickness of the wing 44. The tab 38 bears a cage nut 39.

The air inlet 10 is assembled on the casing 9 by positioning the air inlet 10 on the casing 9 such that the portion 21 of the flange 20 faces the disk 9.2 of the flange 9.1. Screws 90 are then engaged in the perforations 21.2 by passing them through the port 30 from the flow path 16. A clamping tool-here an electric clamping torque wrench-is inserted through the port 30 from the flow path 16 to clamp the screws 90 with the cage nuts 91 and thus apply a clamping force between the flanges 20 and 9.1 to connect the air inlet 10 to the fan casing 9.

The covering 35 is attached onto the air inlet 10 by engaging the tab 38 in the port 30 such that the radially inner face 38.1 of the tab 38 rests on the radially outer face 44.1 of the wing 44. The end 35.1 of the covering 35 then bears against the wing 41. The screw 37 is engaged in the countersink 36 and clamped to work together with the cage nut 43 and the screw 47 is engaged in the countersink 46 and clamped to work together with the cage nut 39. Such an arrangement particularly facilitates assembly and prevents damage to the bolts giving rise to an engagement of the covering 35 in the fan

An air inlet 10 is thus obtained making it possible to carry out the connection operations with the fan casing 9 from the flow path 16, which allows a quicker, easier and therefore more reliable and less costly connection.

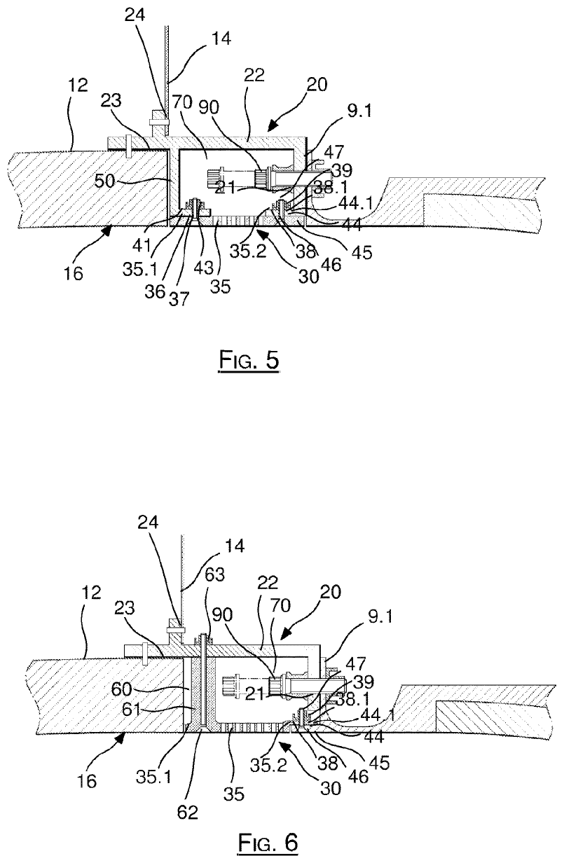

According to a third embodiment shown in FIG. 5, the first inner wing 41 is in material continuity with the flange 20 via a wall 50 extending transversely from the core 22. The second inner wing 44 extends projecting from the bearing face 21.1 to also be in material continuity with the flange 20.

According to a fourth embodiment shown in FIG. 6, the covering 35 comprises, at its upstream end 35.1, a connection base 60 with the core 22 of the flange 20. The base 60 comprises a bore 61 for receiving a screw 62 for attaching the covering 35 to a cage nut 63 borne by the core 22 of the flange 20.

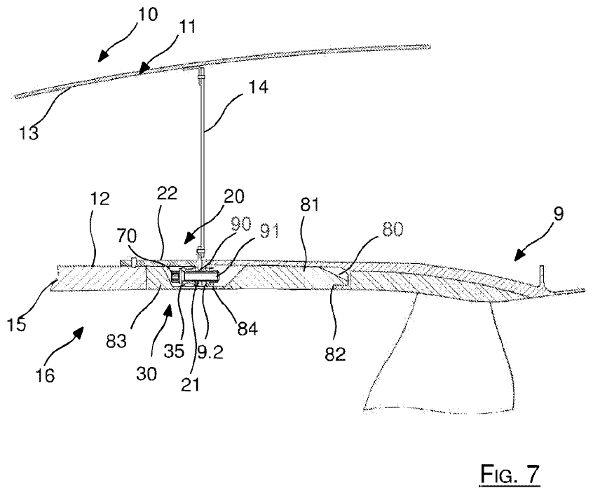

According to a fourth embodiment shown in FIG. 7, the casing 9 comprises a second cavity 80 for accommodating an acoustic panel 81. The acoustic panel 81 is attached by screwing onto the casing 9 and the core 22 and comprises a downstream portion 82 and an upstream portion 83 connected by a central portion 84 which extends plumb with the junction assembly composed of the screw 90, the cage nut 91, the portion 21 of the flange 20 and the disk 9.2. As seen in FIG. 6, the upstream portion 83 partially fills the cavity 70. Thus, the central portion 84 extends, together with a part of the central portion 83, facing the port 30 and fulfills the function of sealing the covering 35. It goes without saying that the invention is not limited to the embodiments described, but encompasses any alternative embodiment that falls within the scope of the invention as defined by the claims.

In particular,
although here the air inlet is of the “extended lip” type, the invention also applies to other types of air inlets such as for example an air inlet wherein a free end of the outer shroud is located in the vicinity of the rear partition;
although here the inner shroud defines the inner wall of an air flow path, the invention also applies to an inner shroud partially defining such a flow path, such as for example an inner shroud connected to another element which would also contribute to the definition of the flow path;
although here the first surface extends circumferentially about the longitudinal axis and the second surface extends in a direction substantially orthogonal to the longitudinal axis, the invention also applies to an air inlet wherein only one of the first and second surfaces extends circumferentially about the longitudinal axis;
although here the casing and air inlet flanges are described as circular revolving elements, the invention also applies to flanges composed of a plurality of ring sectors;
although here the angle is mounted by riveting on the core of the flange, the invention also applies to other means of connecting the angle to the flange such as for example screwing, bolting, bonding, welding or soldering;
although here the removable covering comprises glass fibers agglomerated in a resin, the invention also applies to other types of sound proofing materials;
although here the first inner wing is connected to the flange by a U-shaped profile, the invention also applies to other types of supports such as for example a square, L-shaped profile or a cylinder;
although here the first clamping surface is borne by the core of the flange, the invention also applies to other types of outer portion of the flange extending circumferentially about the longitudinal axis such as for example a mounted tab;
although here the assembly of the air inlet on the housing is carried out using two flat flanges bolted together, the invention also applies to other flange-type assemblies such as for example screwed flanges or conical edge flanges:
although the invention has been described here applied to a propulsion assembly comprising a twin-flow and twin-spool turbojet, the invention also applies to propulsion assemblies comprising other types of turbine engines such as for example a propulsion assembly comprising a twin-flow and single-spool turbojet.

1. An air inlet intended to be connected to a fan casing of a turbine engine by a flange-type assembly, the air inlet comprising an annular structure of longitudinal axis comprising an inner shroud and an outer shroud,
the inner shroud at least partially delimiting a radially outer wall of a flow path of an airflow through the air inlet in a substantially longitudinal direction, the air inlet comprising a flange having a bearing face of a clamping member the air inlet being arranged such that the bearing face is accessible from the flow path via an access port.

2. The air inlet according to claim 1, wherein the flange comprises a core extending substantially longitudinally, the flange also comprising a first portion projecting substantially radially inward from the core the first portion bearing the bearing face.

3. The air inlet according to claim 1, wherein the flange comprises a first clamping connection surface with the inner shroud and/or, the air inlet comprising a rear partition substantially transversely connecting the inner shroud and the outer shroud the flange comprises a second clamping connection surface with the rear partition.

4. The air inlet according to claim 3, wherein the first clamping connection surface extends circumferentially about the longitudinal axis and/or the second clamping connection surface extends in a direction substantially orthogonal to the longitudinal axis.

5. The air inlet according to claim 1, wherein the flange is in material continuity with the inner shroud.

6. The air inlet according to claim 1, comprising a removable covering for sealing the access port.

7. The air inlet according to claim 6, wherein means for attaching the removable covering comprise a first inner wing extending at least partially circumferentially about the longitudinal axis.

8. The air inlet according to claim 6, wherein means for attaching the removable covering comprise a second inner wing extending at least partially circumferentially about the longitudinal axis and located downstream of the first inner wing.

9. A propulsion assembly comprising a turbine engine equipped with an air inlet according to claim 1, the turbine engine comprising a fan casing provided with an upstream flange connected to the flange of the air inlet.

10. A propulsion assembly comprising a turbine engine equipped with an air inlet according to claim 6, the turbine engine comprising a fan casing provided with an upstream flange connected to the flange of the air inlet and wherein the fan casing is arranged to accommodate an acoustic panel which comprises the covering.
